(19) United States
(12) Patent Application Publication
(10) Pub. No.: US 2015/0345716 A1
(43) Pub. Date: Dec. 3, 2015

(54) PORTABLE CEILING LIGHTING FIXTURE

(71) Applicant: Smart Solar Inc., Libertyville, IL (US)

(72) Inventor: John Murphy, Freehold, NJ (US)

(21) Appl. No.: 14/288,275

(22) Filed: May 27, 2014

(51) Int. Cl. F21L 4/02; F21V 1/00; F21V 23/00

(52) U.S. Cl. CPC F21L 4/02; F21V 23/006; F21V 1/00; F21Y 2101/02

(57) ABSTRACT

Disclosed is a portable lighting fixture comprising: a light shade holder; a light shade; a control printed circuit board; an LED printed circuit board having at least one light emitting diode disposed on a first surface of the LED printed circuit board, a battery housing having an open end, the battery housing configured to enclose at least one battery provided by a user of the portable lighting fixture; and a substantially cylindrical cover having an open end, the cylindrical cover open end sized and shaped so as to cover the open end of the battery housing to form an enclosure, the cylindrical cover further having an end sized and shaped for attachment to the light shade holder.

### CROSS REFERENCE TO RELATED APPLICATION

The present application is related to Provisional Patent Application entitled “Wireless Pendant Light,” filed 25 May 2013 and assigned filing No. 61/855,814, incorporated herein by reference in its entirety.

### FIELD OF THE INVENTION

The present invention relates to lighting fixtures which can be moved from location to location and, in particular, portable lighting fixtures that are battery powered, that is, not hard wired, and remotely controlled.

### BACKGROUND OF THE INVENTION

It can be appreciated that wireless and battery-powered lighting fixtures have been commercially available for application to home and commercial use. Typically, conventional wireless lighting units come in standard sizes and are available in various grades of metal or plastic. The main shortcoming with conventional wireless lighting devices is that they are typically available only in a limited configuration, such as a in a wall mounted configuration, or as a handheld lighting device. Additionally, such units are usually configured for single-use, a design that does not provide for ceiling installation or allow for height adjustment.

As such, conventional wireless lighting devices are not suitable for applications which require conformity with popular utility and decor requirements. Another problem is the “cost-versus-benefit” ratio, which can be substantial, especially where ancillary equipment and services are required. In these respects, the versatility and economy of the present invention departs from conventional concepts and designs of the prior art and, in so doing, provides an apparatus having a more effective use for lighting devices, and further provides versatility of easy access to vertical height adjustment.

### BRIEF SUMMARY OF THE INVENTION

In one aspect of the present invention, an LED pod comprises: a control printed circuit board; an LED printed circuit board having at least one light emitting diode disposed on a first surface of the LED printed circuit board, the LED printed circuit board having a second surface configured for electrical attachment to a control circuit power source; a battery housing having an open end, the battery housing configured to enclose at least one battery provided by a user of the LED pod unit, the battery housing further having a second end configured to provide electrical power to the control printed circuit board; and a substantially cylindrical cover having an open end, the cylindrical cover open end sized and shaped so as to cover the open end of the battery housing to form an enclosure, the cylindrical cover further having a second end sized and shaped for attachment to a pendant lighting fixture.

In another aspect of the present invention, a portable lighting fixture comprises: a light shade holder; a light shade secured to the light shade holder; a control printed circuit board; an LED printed circuit board having at least one light emitting diode disposed on a first surface of the LED printed circuit board, the LED printed circuit board having a second surface configured for electrical attachment to the control circuit a power source; a battery housing having an open end, the battery housing configured to enclose at least one battery provided by a user of the portable lighting fixture, the battery housing further having a second end configured to provide electrical power to the control printed circuit board; and a substantially cylindrical cover having an open end, the cylindrical cover open end sized and shaped so as to cover the open end of the battery housing to form an enclosure, the cylindrical cover further having a second end sized and shaped for attachment to the light shade holder.

The additional features and advantage of the disclosed invention is set forth in the detailed description which follows, and will be apparent to those skilled in the art from the description or recognized by practicing the invention as described, together with the claims and appended drawings.

### BRIEF DESCRIPTIONS OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is an exploded isometric view of a pendant lamp fixture suitable for use with a lighting unit, in accordance with the present invention;

FIG. 2 is an exploded isometric view of a light emitting diode (LED) pod unit, as may be used in the pendant lamp fixture of FIG. 1;

FIG. 3 is a diagrammatical illustration of the pod unit of FIG. 2 in an unassembled state, showing a battery housing, batteries, and a cover;

FIG. 4 is a diagrammatical illustration of the pod unit of FIG. 3 in an assembled state, showing the battery housing and the cover;

FIG. 5 is a diagrammatical illustration of the pod unit of FIG. 4 as may be secured into a pendant lamp fixture; and

FIG. 6 is with a selection of attachable mood caps of various colors.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. It is to be understood that the phraseology and terminology employed herein are for the purpose of the description and should not be regarded as limiting.

Additionally, the invention can be operated manually or remotely using a remote control device, and can be affixed to any surface to act as a light switch. The portable lighting fixture also has the built-in ability to adjust to any height desired with a simple manual operation. The height can be adjusted to accommodate decor, or changes in furniture placement, for example.

Moreover, the disclosed lighting fixtures eliminate the need for a licensed technician during the installation process, and eliminates the necessity for wall damage or creating visible openings or access holes in walls and ceilings. The average homeowners can thus easily install a portable pendant light on any permanent ceiling without consideration of obstructed or compromised construction conditions.

Another object is to provide a method for “after-the-fact” vertical adjustment of the device, as required to satisfy changing physical conditions and decor requirements. Another object is to provide a lighting device that can be operated remotely, using a portable or affixed remote control device. Other objects and advantages of the present invention will become obvious to the reader and it is intended that these object and advantages are within the scope of the present invention.

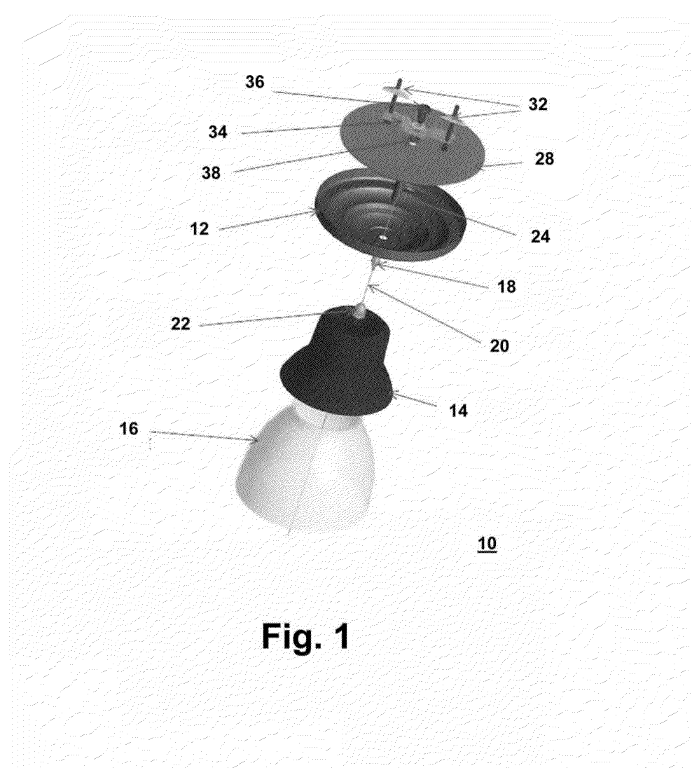

FIG. 1 shows a pendant lighting fixture 10 comprising a ceiling cover 12, a light shade holder 14, and a translucent or patterned light shade 16. The light shade holder 14 may be attached to the ceiling cover 12 with a steel wire 20, a wire clamper 18, a coronal nut 22, and a screw rod 24. The pendant lighting fixture 10 may be attached to a ceiling or other horizontal mounting surface by toggle bolts 32, a mounting bracket 34, a screw 36, and a nut 38 positioned on the screw 36. The screw 36 may be attached to one end of the screw rod 24 so as to hold the mounting bracket 34 and a circular cardboard insert 28 against the ceiling cover 12.

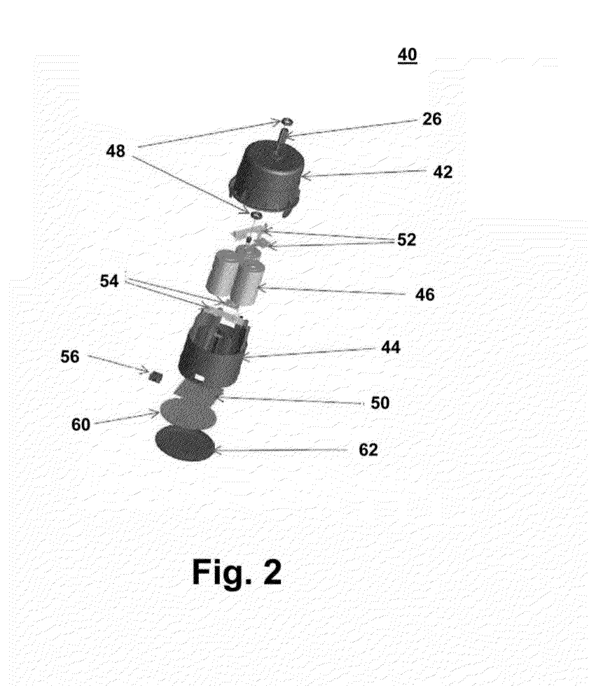

There is shown in FIG. 2 shows a light emitting device (LED) pod unit 40 sized and configured for insertion into the pendant lighting device 10, shown in FIG. 1. The LED pod unit 40 may be adapted for attachment to the pendant lighting device 10 by a screwing motion, or by a push-and-twist motion, as known in the art. The LED pod unit 40 includes a cylindrical cover 42 having an open end, a battery housing 44 configured to mate with the cylindrical cover 42, and one or more batteries 46 sized to fit into the enclosure formed by placement of the cylindrical cover 42 onto the battery housing 44.

There is shown in FIG. 2 shows an exemplary embodiment of a light emitting device (LED) pod unit 40 sized and configured for insertion into for attachment to the pendant lighting device 10, shown in FIG. 1. The LED pod unit 40 may be adapted for attachment to the pendant lighting device 10 by a screwing motion, or by a push-and-twist motion, as known in the relevant art. The LED pod unit 40 includes a cylindrical cover 42 having an open end, a battery housing 44 configured to mate with the cylindrical cover 42 so as to form an enclosure. Accordingly, one or more batteries 46 may be appropriately sized and shaped so as to fit into the enclosure formed by placement of the cylindrical cover 42 onto the battery housing 44. The one or more batteries 46 are typically not included, but may be provided by a purchaser or user of the LED pod unit 40. Although the cylindrical cover is here shown as having a substantially cylindrical cross section, it should be understood that any cross section can be used so as to both enclose and support the one or more batteries 46 used by the LED pod unit 40.

A first battery contact plate 52 may be provided to electrically connect two or more batteries 46, and a second battery contact plate 54 may be provided to electrically connect the batteries 46 to a control printed circuit board 50. An electrical switch 56 may be electrically connected to the battery housing 44 and to the control printed circuit board 50 as a means of operationally controlling the LED pod unit 40. Alternatively, the control printed circuit board 50 may include a wireless receiver (not shown) to allow for remotely controlling the “on” or “off” status of the LED pod unit 40, as described in greater detail below. In an exemplary embodiment, the control printed circuit board 50 is sized and shaped to fit into the battery housing 44. A screw rod 26 may be provided along with nuts 48 to aid in assembly of the LED pod unit 40.

The control printed circuit board 50 functions to selectively power a light-emitting diode printed circuit board 60 using a wireless receiver in communication with a remote control, as known in the art, to allow for selectively and remotely powering the LED pod unit 40, as described in greater detail below. A transparent protection lens 62 may be provided to protect the light-emitting end of the LED pod unit 40. In an exemplary embodiment, the light-emitting diode printed circuit board 60 is sized and shaped to fit into the battery housing 44 substantially as shown.

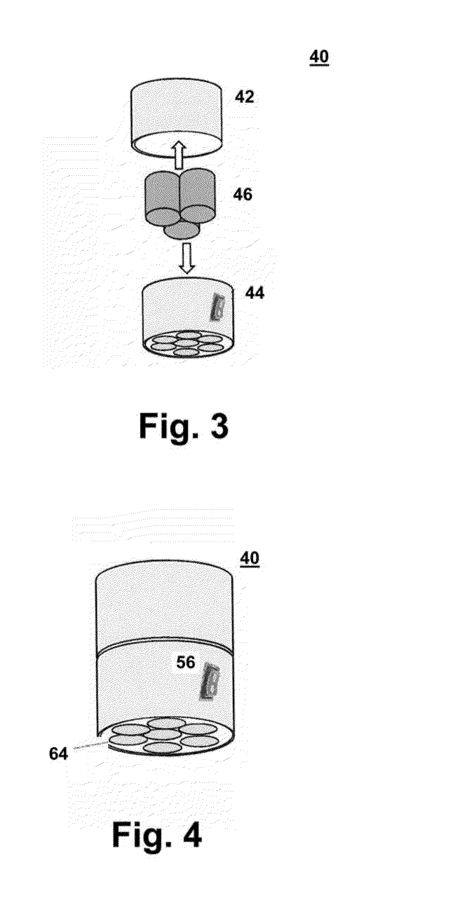

FIG. 3 is another illustration of the LED pod unit 40 in an unassembled state, showing that the batteries 44 may be inserted into the battery housing 44 before the cylindrical cover 42 is placed over the battery housing 44. FIG. 4 shows the LED pod unit 40 in an assembled state. The switch 56 is used to control the array of light emitting diodes 64 disposed at the light-emitting end of the LED pod unit 40. In the configuration shown, the LED pod unit 40 can be used as a hand-held device and serve as a flashlight, in emergency situations, for example.

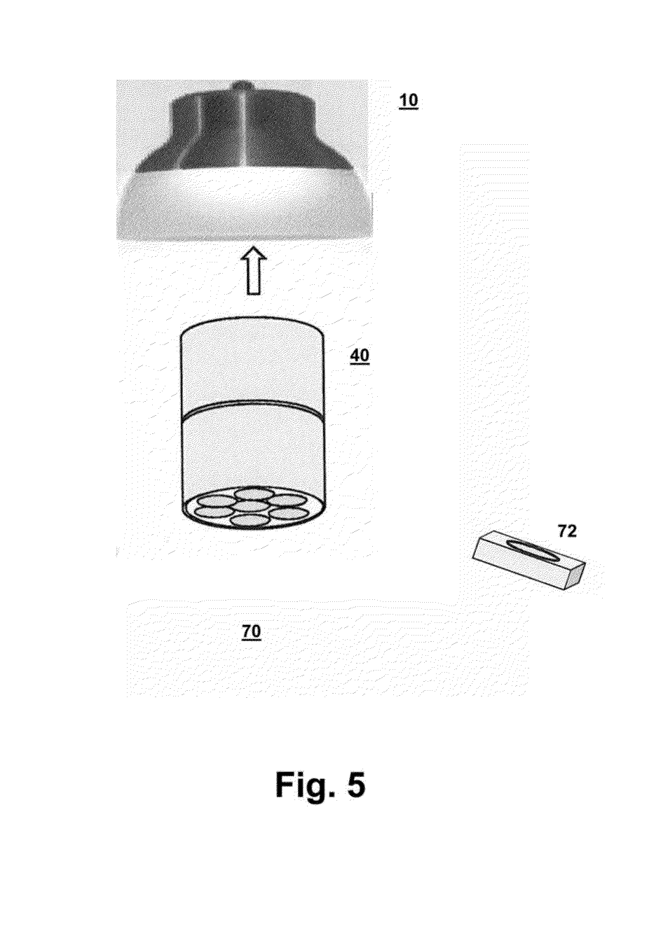

It can be appreciated that the LED pod unit 40 is readily insertable into the pendant lighting fixture 10, as shown in FIG. 5, to form a portable lighting fixture 70 that can be placed at a location of the user's choice. A remote control unit 72 may be provided for the user to enable controlling the lighting at a distance from the portable lighting fixture 70.

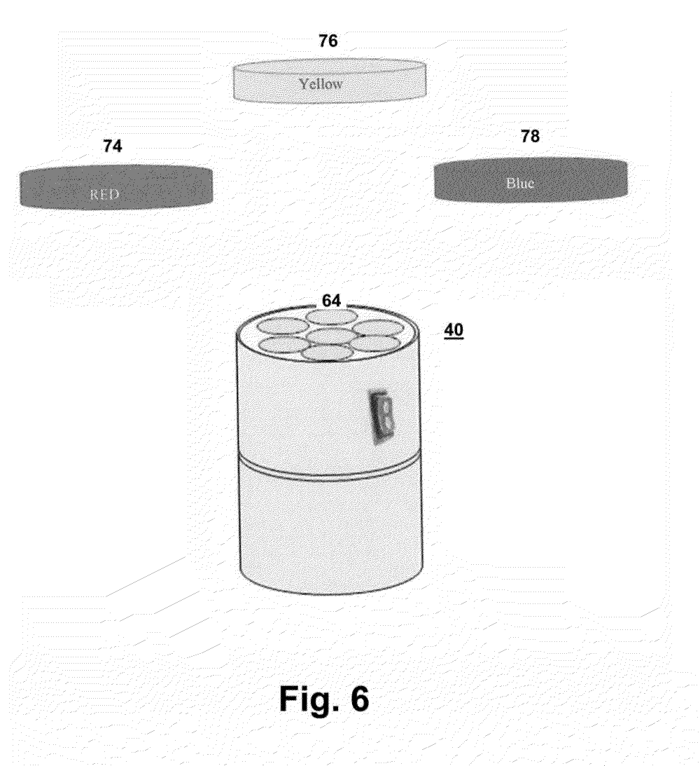

In an alternative embodiment, shown in FIG. 6, a light filter or “mood” cap may be disposed over the light-emitting diodes 64 in the LED pod unit 40, so as to change the color content of the light output emanating from the light-emitting diodes 64. In the example provided, is one or more of a red cap 74, a yellow cap 76, and a blue cap 78 are sized and shaped to frictionally engage the light-emitting end of the LED pod unit 40. In an exemplary embodiment, the colored cap 74, 76, 78 may be placed over or pushed onto the light-emitting end of the LED pod unit 40, and then turned to more positively secure the colored cap 74, 76, 78 in place. As described above, the LED pod unit 40 may be used with a colored cap 74, 76, 78 either: (i) in the pendant lighting fixture 10 in a deco application, or (ii) as a portable lighting device described above.

It is to be understood that the description herein is only exemplary of the invention, and is intended to provide an overview for the understanding of the nature and character of the disclosed lighting fixtures. The accompanying drawings are included to provide a further understanding of various features and embodiments of the method and devices of the invention which, together with their description serve to explain the principles and operation of the invention.

What is claimed is:

1. An LED pod unit comprising:
a control printed circuit board;
an LED printed circuit board having at least one light emitting diode disposed on a first surface of said LED printed circuit board, said LED printed circuit board having a second surface configured for electrical attachment to said control printed circuit board;
a battery housing having an open end, said battery housing configured to enclose at least one battery provided by a user of said LED pod unit, said battery housing further having a second end configured to provide electrical power to said control printed circuit board; and
a cover having an open end, said cover open end sized and shaped so as to cover said open end of said battery housing to form an enclosure, said cover further having a second end sized and shaped for attachment to a pendant lighting fixture.

2. The LED pod unit of claim 1 further comprising an electrical switch electrically connected between said control printed circuit board and said battery housing.

3. The LED pod unit of claim 1 wherein said LED printed circuit board is sized and configured to fit into said battery housing.

4. The LED pod unit of claim 1 wherein the cover has a cylindrical shape.

5. A portable lighting fixture comprising:
a light shade holder;
a light shade secured to said light shade holder;
a control printed circuit board;
an LED printed circuit board having at least one light emitting diode disposed on a first surface of said LED printed circuit board, said LED printed circuit board having a second surface configured for electrical attachment to said control printed circuit board;
a battery housing having an open end, said battery housing configured to enclose at least one battery provided by a user of said portable lighting fixture, said battery housing further having a second end configured to provide electrical power to said control printed circuit board; and
a cover having an open end, said cylindrical cover open end sized and shaped so as to cover said open end of said battery housing to form an enclosure, said cover further having a second end sized and shaped for attachment to said light shade holder.

6. The portable lighting fixture of claim 5 wherein said control printed circuit board is sized and configured to fit into said battery housing.

7. The portable lighting fixture of claim 5 further comprising a remote control operable to remotely control said portable lighting fixture.

8. A battery-powered LED pod enclosure comprising:
an upper cover, having an open lower end;
a battery housing having an upper end removably secured to the upper cover;
one or more batteries positionable within the battery housing;
one or more LEDs positioned on a lower end of the battery housing;
a lens secured to the lower end of the battery housing beneath the one or more LEDS;
an electrical circuit between the one or more batteries and the one or more LEDs;
a switch positioned in the electrical circuit movable from a first ON position where electricity is provided from one or more batteries within the battery housing to the one or more LEDs to a second OFF position where electricity is not provided from the one or more batteries to the one or more LEDs.

9. The battery-powered LED pod enclosure of claim 8, wherein the switch is manually manipulable to move the switch from the first ON position to the second OFF position.

10. The battery-powered LED pod enclosure of claim 8, where in the switch is operable from a wireless remote control.

11. The battery-powered LED pod enclosure of claim 8, wherein an upper end of the battery housing is positioned within the lower end of the upper cover.

12. The battery-powered LED pod enclosure of claim 8, wherein a threaded member extends from a top surface of the upper cover, and the threaded member is adapted for attachment to a lamp shade.

13. The battery-powered LED pod enclosure of claim 11, wherein the upper cover has a cylindrical shape and a portion of the battery housing extending beneath the lower open end of the upper cover also has a cylindrical shape.
